(19) United States
(12) Patent Application Publication
(10) Pub. No.: US 2024/0311790 A1
(43) Pub. Date: Sep. 19, 2024

(54) LOW-POWER SELF-CHECKOUT SHOPPING DEVICE

(71) Applicant: Machyna Inc., Encinitas, CA (US)

(72) Inventors: Victor Hokkiu Chan, Del Mar, CA (US); Raylen Hong-Rui Li, San Diego, CA (US)

(21) Appl. No.: 18/412,963

(22) Filed: Jan. 15, 2024

Related U.S. Application Data
(60) Provisional application No. 63/439,053, filed on Jan. 13, 2023.

(51) Int. Cl. G06Q 20/20; G06Q 20/18

(52) U.S. Cl. CPC G06Q 20/208; G06Q 20/18

(57) ABSTRACT

A system and method for a low-power, self-checkout shopping device. A system and method of operations include one or more image sensors arranged on the shopping device, and computer hardware connected with the one or more image sensors. The computer hardware is configured to perform operations including demarcate an area of interest associated with the shopping receptacle within a field of view (FOV) of the one or more image sensors, and detect one or more features of one or more products that are imaged by the one or more image sensors in the area of interest associated with the shopping receptacle. The operations further include associate the detected features of the one or more products with a product database to determine a product identification for each of the one or more products that are imaged by the one or more image sensors.

### TECHNICAL FIELD

The subject matter described herein relates to a smart shopping cart, and more particularly to a shopping cart having a multi-state pipeline, and more particularly to a low-power self-checkout shopping device.

### BACKGROUND

Smart shopping carts, where technology integrated with the cart can identify and log items put into the cart, can assist in the checkout and payment process, as well as aiding in accomplishing or fulfilling a shopping list, etc. But most conventional smart shopping carts utilize only a code scanner for scanning a barcode, QR code, or the like.

### SUMMARY

This document describes a low-power, self-checkout shopping device such as a cart or a basket or other receptacle. In one aspect, the shopping device utilizes software on a chip that is integrated with each shopping device, thereby obviating any need for connectivity such as wireless or wired connectivity. However, the shopping device described herein can further include one or more forms of connectivity, such as Bluetooth, WiFi, cellular, or the like.

In some aspects, a system and method for a low-power, self-checkout shopping device. A system, and its method of operations, include one or more image sensors arranged on the shopping device, and computer hardware connected with the one or more image sensors. The computer hardware is configured to perform operations including demarcating an area of interest associated with the shopping receptacle within a field of view (FOV) of the one or more image sensors, and detecting one or more features of one or more products that are imaged by the one or more image sensors in the area of interest associated with the shopping receptacle.

In some aspects, the operations further include associating the detected features of the one or more products with a product database to determine a product identification for each of the one or more products that are imaged by the one or more image sensors, recognizing the product identification for each of the one or more products in the shopping receptacle, and displaying the product identification for each of the one or more products in an electronic display.

In some aspects, the operations can further include identifying dynamic content within the area of interest associated with the shopping receptacle, the dynamic content related to image content from the one or more image sensors that changes over time. The operations can further include processing only the dynamic content to determine one or more features of an additional product that is imaged by the one or more sensors.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to low-power self-checkout shopping device, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a process flow diagram illustrating aspects of a method having one or more features consistent with implementations of the current subject matter.

When practical, similar reference numbers denote similar structures, features, or elements.

### DETAILED DESCRIPTION

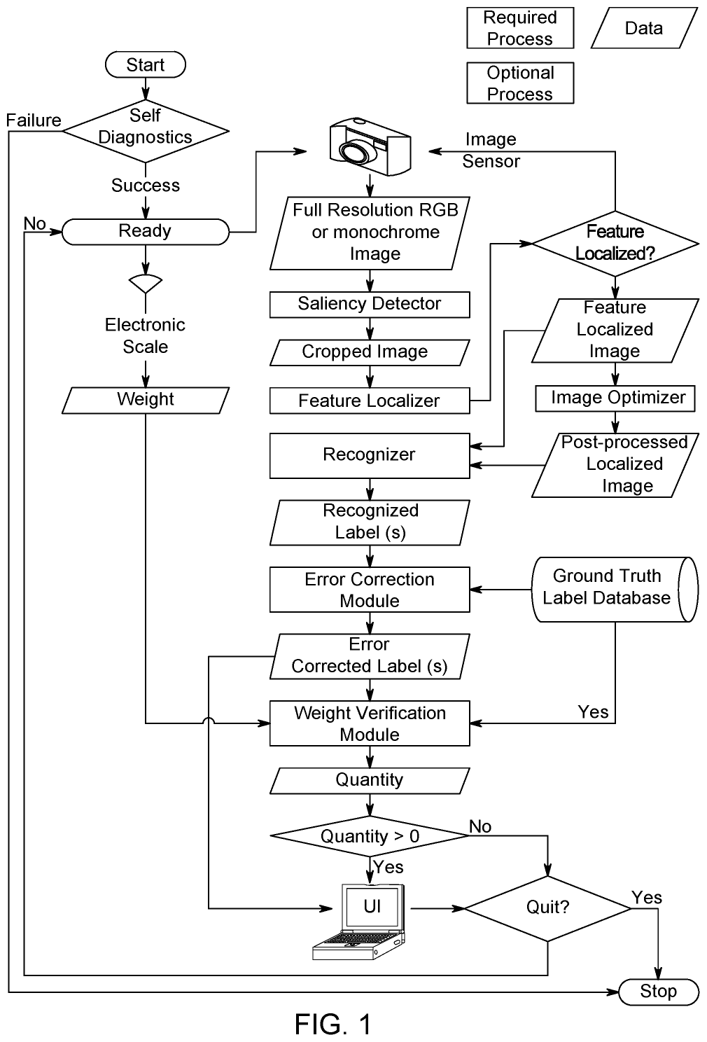

This document described a low-power, self-checkout shopping device, having a multi-state recognition pipeline for recognizing and registering products that are placed into the shopping device. In some implementations, and as illustrated in FIG. 1, a multi-state recognition pipeline includes one or more of a saliency detector, a change detector, a feature detector, a feature recognizer, a product database, a scale, and/or an UI display and light indicator. The multi-state recognition pipeline, and its component parts, is described further below.

Saliency detector: in preferred implementations, a saliency detector is configured to demarcate only the area of interest within the field of view (FOV) of one or more image sensors. Specifically, due to the mounting angle of an image sensor, the FOV might cover areas that are of no interest to the self-checkout device. For example, in a smart shopping cart, due to the use of wide-angle lenses, an image's FOV might cover from the ceiling to the base of the shopping cart. But the area of the ceiling is not an area of interest since a product will rarely or never enters the FOV from such extreme angles, so it is more efficient for the system to mark out a salient area so that only the image content from that area is processed. Likewise, the non-salient areas are ignored so that data reduction is performed at the earliest stage of the processing pipeline.

Change detector: To identify dynamic content within the salient area. Once the salient area is established, an image sensor will capture and process the image area. However, if image content has changed over time within the salient area, then it would be a waste of power and time to continuously process the image area. Accordingly, the Change Detector is configured to separate dynamic content within the salient area from static content, so that only the dynamic content will be processed. In some implementations, the Change Detector has three essential components: a Reference image (R), a Current image (C), and a Threshold image (T). When the following condition is satisfied, then the pixels or blocks of pixels will be retained for the next stage of processing: C−R>=T.

For further efficiency improvement, the R, C, and T images are sub-sampled or decimated from the original images, so that the image size of these images are straightly smaller than that of the original images. The Reference image is an average of n number of previous frames which can be established at the start of the system or periodically updated throughout the operation of the system.

The averaging method can be a simple of average pixel value of the frames. Or, the averaging method can be a linear weighted sum of the frames where the more recent frames are weighted linearly more than the older frames. Further still, the averaging method can be an exponential average such as an IIR filter where the more recent frames are weighted much more heavily than the older frames.

The Current image is the image under consideration for Change Detection. While the current image can be the most recently available image from the image sensor, for efficiency consideration, the most recently available image may be skipped periodically.

Most Recently Available Current Image: Frame 1, Frame 2, Frame 3, Frame 4, Frame 5 . . . are all processed by the Change Detector as Current images.

Periodic Current Image: Frame 1, Frame 4, Frame 7, Frame 10 . . . . Thereby skipping Frame 2, 3, 5, 6, 8, 9, etc. While it is generally recommended that the Most Recently Available Current Images are always processed by the Change Detector, when the system is stressed due to resource constraints, the system might switch to using Periodic Current Image mode to spare the processing resources. After all, temporally adjacent frames can be similar to one another and is more likely to contain redundant image content. The period of the Periodic Current Image can be established automatically or manually.

The Threshold image establishes the minimum change or difference between Reference and Current images for the Current image to be qualified as “changed”. The value of the Threshold image can be a single value across the entire image which is fixed. The value of the Threshold image can be a single value across the entire image, but it is dynamically adjusted based on the average brightness of the Current Image. For example, you want to use a larger Threshold value for a brighter image vs. a darker image. The value of the Threshold image can be a single value across the entire image, but it is dynamically adjusted based on global contrast (i.e. max pixel value minus min pixel value) of the Current image. For example, I a low-contrast Current image, you don't want to use the same threshold as the high-contrast Current image. The value of the Threshold image uses different values across the image depending on the regional image statistics of the Current image. The image statistics can be regional brightness, regional contrast, etc.

Feature Localizer: Once the Change Detector identifies the subset of the Current image that has dynamically changed, that Changed area will need to be examined closely for product identification. Since the computational cost of performing feature recognition is very high, it is inefficient to perform product identification on the entire Changed image. To improve processing efficiency, a Feature Localizer is used to ascertain whether essential features are present in a local area (an image patch) of the Changed Image. If an area of the Changed image contains sufficient features, then and only then that image patch is moved forward ti the Recognizer. The Feature Localizer algorithm must be computationally efficient, otherwise there is no benefit in running it. In other words, O (Feature Localizer (Changed Image))<O (Recognizer (Changed Image)). An example of the Feature Localizer can be implemented as a Barcode Localizer such that if a barcode is present in an image, the localized image area is extracted for Barcode Recognition.

Recognizer: This is often the most computationally intensive part of the algorithm. If the Feature Detector had successfully localized an image patch as containing the feature (for example, a barcode, a QR code, a graphical label, etc.). then the Recognizer will try to recognize its identity. The output of the Recognizer can be a single label or a sequence of label.

Error Correction using a Product Database. After the Recognizer has produced a label or a sequence of labels based on the input image, this information is then checked against the ground truth stored in the Product Database. If an exact match is found, then the label(s) is reported, and a successful recognition has been found. If no exact match is found, then the set of labels that has the least amount of “Edit Distance” or necessary corrections are reported the recognized product. In this case, there can be more than one product being recognized and a user is prompted to disambiguate the reported choices.

Scale: There are auxiliary modalities that can be used to increase the robustness of the self-checkout system. When a product is inserted into the smart cart, the measured weight will be checked against the expected weight of the recognized product. If the measured weight is an integer multiple of the expected weight, then the integer value is reported as the quantity of the products received. If the measured weight is not an integer multiple of the expected weight, then an error is generated, and the user will be prompted to resolve the ambiguity.

Light and Sound indicators. Light and sound can be used as user feedback to increase the robustness of the system. A chime can be played when a product has been recognized. Similarly, a light (such as green light) can be turned on when a product is recognized. When a user presents a product to the system, based on response rate of the Localizer, a light (with variable frequency or intensity) or sound (with variable frequency) can be played so that a user can use the feedback to optimize the presentation of the product to the self-checkout system.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A low-power, self-checkout shopping receptacle comprising:
one or more image sensors arranged on the shopping receptacle; and
computer hardware connected with the one or more image sensors, and configured to perform operations comprising:
demarcate an area of interest associated with the shopping receptacle within a field of view (FOV) of the one or more image sensors;
detect one or more features of one or more products that are imaged by the one or more image sensors in the area of interest associated with the shopping receptacle; and
associate the detected features of the one or more products with a product database to determine a product identification for each of the one or more products that are imaged by the one or more image sensors.

2. The low-power, self-checkout shopping receptacle in accordance with claim 1, wherein the operations further comprise:
identify dynamic content within the area of interest associated with the shopping receptacle, the dynamic content related to image content from the one or more image sensors that changes over time; and
process only the dynamic content to determine one or more features of an additional product that is imaged by the one or more sensors.

3. The low-power, self-checkout shopping receptacle in accordance with claim 1, wherein the operations further comprise:
recognize, using computational logic and the product database, the product identification for each of the one or more products in the shopping receptacle; and
display the product identification for each of the one or more products in an electronic display.

4. The low-power, self-checkout shopping receptacle in accordance with claim 1, wherein the operations further comprise, wherein the computer hardware comprises:
a programmable processor; and
a non-transitory machine-readable medium storing instructions that, when executed by the processor, cause the at least one programmable processor to perform at least some of the operations.

5. The low-power, self-checkout shopping receptacle in accordance with claim 1, wherein the one or more features includes a barcode.

6. A system comprising:
a shopping receptacle configured to be moved within a shopping environment;
one or more image sensors arranged on the shopping receptacle; and
computer hardware connected with the one or more image sensors, and configured to perform operations comprising:
demarcate an area of interest associated with the shopping receptacle within a field of view (FOV) of the one or more image sensors and within the shopping environment;
detect features of one or more products that are imaged by the one or more image sensors in the area of interest associated with the shopping receptacle; and
associate the detected features of the one or more products with a product database to determine a product identification for each of the one or more products that are imaged by the one or more image sensors.

7. The system in accordance with claim 6, wherein the operations further comprise:
identify dynamic content within the area of interest associated with the shopping receptacle, the dynamic content related to image content from the one or more image sensors that changes over time; and
process only the dynamic content to determine features of an additional product that is imaged by the one or more sensors.

8. The system in accordance with claim 6, wherein the operations further comprise:
recognize, using computational logic and the product database, the product identification for each of the one or more products in the shopping receptacle; and
display the product identification for each of the one or more products in an electronic display.

9. The system in accordance with claim 6, wherein the one or more image sensors includes a barcode reader.

10. The system in accordance with claim 6, wherein the one or more image sensors includes a QR code reader.
